(19) United States
(12) Patent Application Publication
(10) Pub. No.: US 2009/0165815 A1
(43) Pub. Date: Jul. 2, 2009

(54) AVOIDING ELECTRICAL SHORTS IN PACKAGING

(75) Inventors: Debbie Tuerca ALCALA, Singapore (SG); Hendri Yanto KWEE, Singapore (SG); Michael TI-IN, Singapore (SG); Kian Teng ENG, Singapore (SG); Rodel MANALAC, Singapore (SG); Jimmy SIAT, Singapore (SG)

Correspondence Address: HORIZON IP PTE LTD, 7500A Beach Road, #04-306/308 The Plaza, SINGAPORE 199591, SG

(73) Assignee: UNITED TEST AND ASSEMBLY CENTER LTD., Singapore (SG)

(21) Appl. No.: 12/326,908

(22) Filed: Dec. 3, 2008

Related U.S. Application Data
(60) Provisional application No. 60/991,761, filed on Dec. 3, 2007.

(51) Int. Cl. H05H 1/00; B08B 7/00

(52) U.S. Cl. 134/1.1; 422/186.05

(57) ABSTRACT

A plasma clean tool that includes a cleaning chamber for cleaning an article by plasma cleaning and a charge shield for surrounding an article to be cleaned is presented. The charge shield prevents charged components of plasma from passing therethrough to charge the article during plasma cleaning of the article.

### BACKGROUND

Plasma is an ionized gas which can be formed by excitation of the gas through external energy sources such as microwave, radio frequency (RF) or direct current (DC). Plasma species are highly reactive due to its tendency to bond with other elements to revert back to their initial state or normal form. Based on its highly reactive characteristics, plasma has become a very useful method for surface modification (physically/chemically) or surface cleaning. In the semiconductor industry, for example, in IC packaging, plasma is generally used to prepare a surface for wire bonding to improve bond strength or to prepare a surface for encapsulation to eliminate delamination which is a major reliability issue. However, we have discovered that post wire bonding plasma treatment can cause wire short failures.

From the foregoing discussion, it is desirable to reduce or prevent wire shorting defects caused by post wire bonding plasma treatment.

### SUMMARY

Embodiments generally relate to a plasma clean tool and a method for fabricating a device. In one embodiment, a plasma clean tool that includes a cleaning chamber for cleaning an article by plasma cleaning and a charge shield for surrounding an article to be cleaned is disclosed. The charge shield prevents charged components of plasma from passing therethrough to charge the article during plasma cleaning of the article.

In another embodiment, a handler used in a plasma clean process of manufacturing integrated circuits (ICs) is presented. The handler includes a support on which articles to be cleaned are disposed and a charge shield that surrounds the support to prevent passage of charged components of plasma from passing through and accumulate on the articles during plasma cleaning.

A method for fabricating a device is disclosed in one embodiment. The method includes providing a device on a handler. The handler is placed in a plasma chamber. A charge shield that surrounds the device is provided. The method further includes cleaning the device by plasma cleaning in the plasma chamber. The charged components of plasma are prevented from passing through the shield and accumulating on the device.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows plasma species of oxygen;

FIG. 2 illustrates phenomenon of wire short after plasma process is performed;

FIG. 3 shows charges built up during plasma process; and

FIG. 4(a) shows an embodiment of a plasma system, while FIGS. 4(b) and (c) show embodiments of a magazine for use in the plasma system.

### DETAILED DESCRIPTION

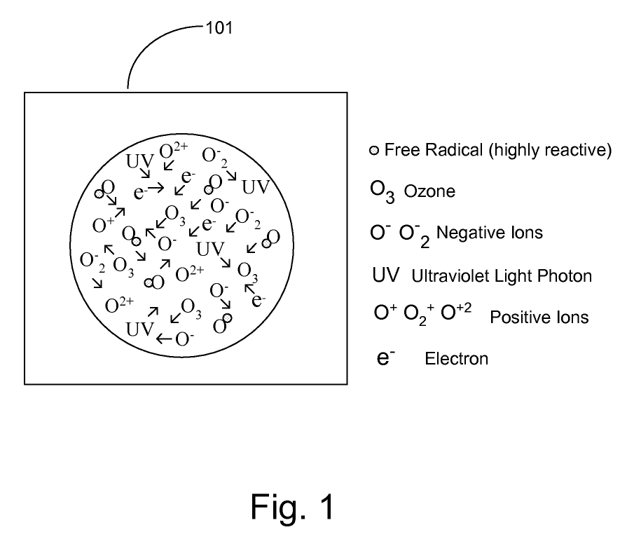

FIG. 1 shows a typical plasma 101. As shown, the plasma species comprises oxygen. It should be understood that while an oxygen plasma species is shown, plasma species of other types of gasses may also be used. The plasma includes ions, electrons, free radicals, and photons generated from the application of electromagnetic radiation to a gas. The plasma can be employed in, for example, cleaning in integrated circuit (IC) processing. In one embodiment, the plasma is used to clean IC packages after wire bonding. Plasma cleaning prepares the surface for encapsulation.

We have discovered that post wire bonding plasma cleaning can cause wire short failures. Not to be bound by theory, it is believed that during plasma cleaning, ions and electrons may attach to the wire bonds, building up charge. As the charge builds up in the wire bonds, oppositely charged wires attract which causes shorting of wires.

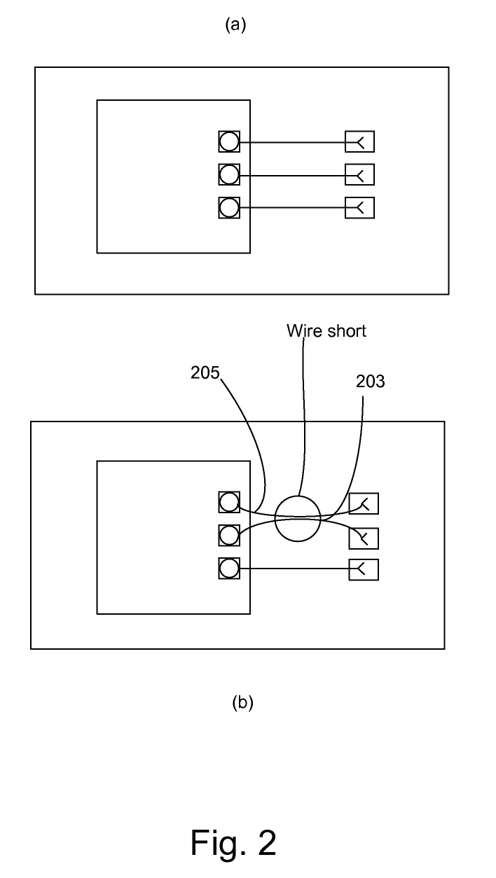

Referring to FIG. 2, (a) shows wire bonds on a die that correspond to wire bonds on a lead frame/substrate. All the wires should be straight as shown in (a). However, as shown in (b), as a result of the build up of opposite charges on, for example, the wires 203 and 205, they attract to each other causing a short.

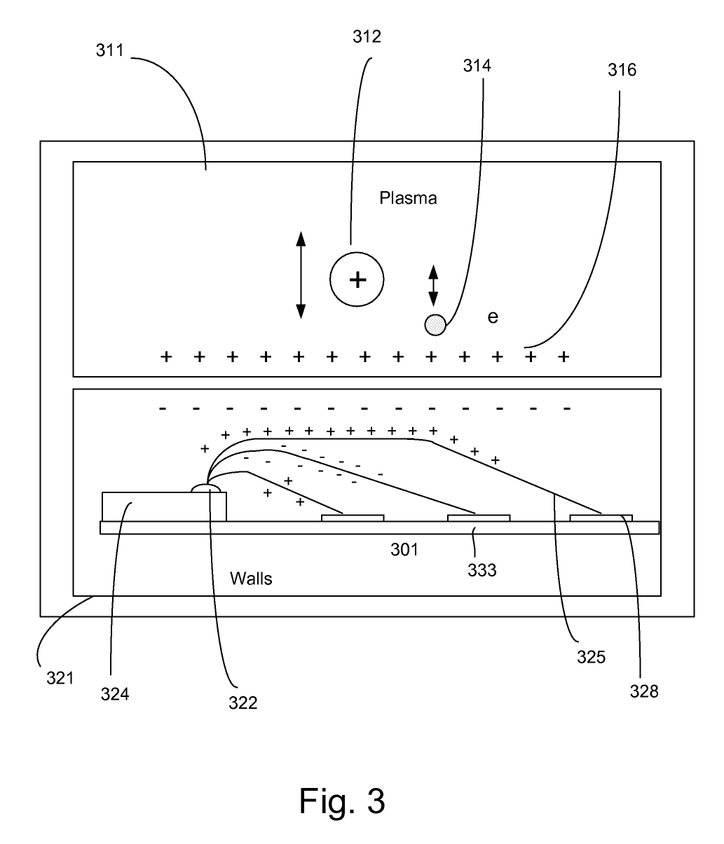

FIG. 3 illustrates a plasma process. In one embodiment, the plasma process comprises a microwave plasma process. Other types of plasma processes are also useful. Gas source is excited in a plasma chamber 311 to generate plasma. The plasma components, such as positive ions 312, free radicals 314 and electrons 316 are generated. Of course, the plasma includes other components (not shown). The plasma components oscillate along the direction of the applied electric field, indicated by the arrows. Generally, the heavier components, such as positive ions, have a smaller oscillation than the lighter components, such as electrons.

For example, a wire bonded package 301 in preparation for encapsulation is provided in cleaning chamber 321. As shown, the package includes a die 324 mounted on a lead frame or substrate 333. To electrically couple the die to the substrate, wire bonds are provided. For example, wires 325 are bonded to die pads 322 on the die and pads 328 on the substrate. During cleaning, charged components of the plasma, such as ions and electrons surround the wires, thereby causing charges to accumulate on the wires. Oppositely charged wires attract which can result in shorting of the wires.

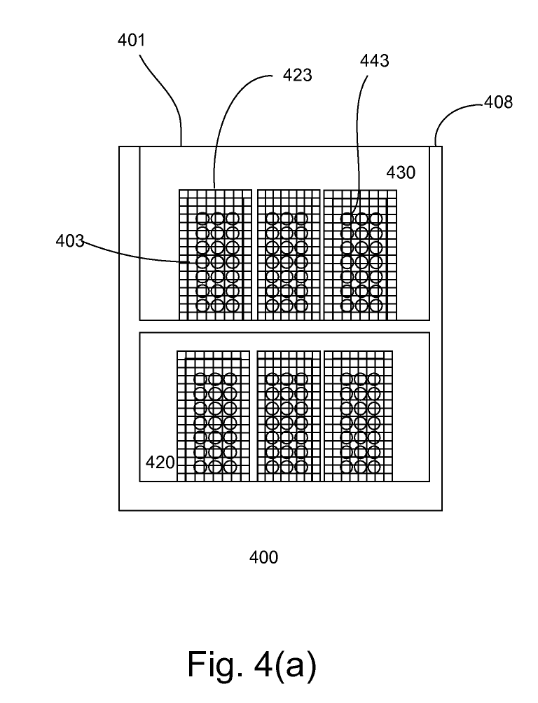

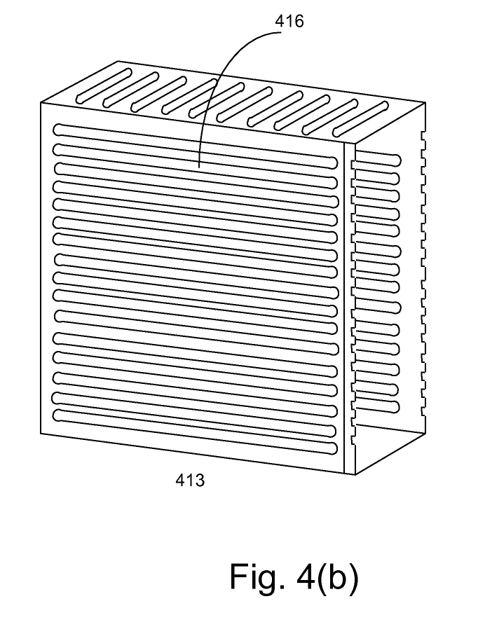

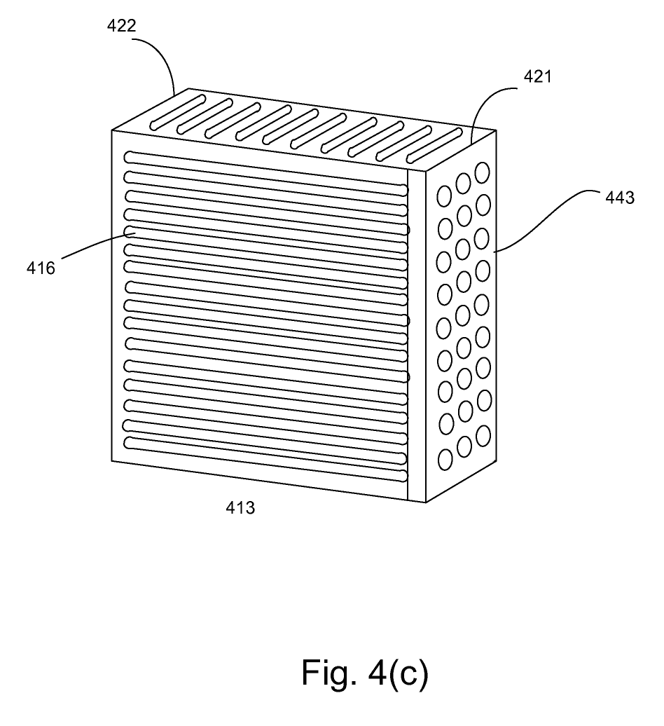

Referring to FIG. 4(a), an embodiment of a plasma system 400 is shown. The plasma system 400 can be based on various types of plasma systems. For example, plasma system 400 can be based on a system manufactured by TEPLA, Balzer or March. Other types of plasma systems may also be employed. The plasma system 400 comprises a plasma cleaning chamber 401. In one embodiment, the chamber comprises first and second levels or decks 420 and 430. The levels correspond to, for example, upper and lower levels. Providing a chamber with other number of levels, including 1, is also useful. Walls 408 are electromagnetic fields that help to distribute the plasma.

Articles to be cleaned are placed in the cleaning chamber. For example, the articles can be disposed on a support or handler 403 which is placed in the cleaning chamber. The handler can be selected to hold one or a plurality of articles to be cleaned. A plurality of handlers can be placed on the different levels of the cleaning chamber. In one embodiment, the handler includes a charge shield 423. The charge shield, in one embodiment, can be integrated as part of the handler or as a separate component. The charge shield prevents charged particles of the plasma, such as ions and electrons from passing through to the article. This prevents charge from being accumulated on the article. On the other hand, the shield allows other components, such as free radicals, to pass through to clean the article.

The plasma system can be used to, for example, clean IC packages after wire bonding. The packages may be cleaned to prepare for encapsulation. The plasma system can also be used to treat other articles to prevent building of charges. For cleaning of IC packages, the packages can be placed on the handler. The shield surrounds the handler to prevent charged components from passing through and accumulate on, for example, wire bonds.

In one embodiment, the handler comprises a magazine which is used to contain the articles, such as wire bonded packages prior to encapsulation. Other types of handlers are also useful. The charge shield, in one embodiment, can be integrated as part of the magazine or as a separate component.

FIG. 4(b) shows an embodiment of a magazine 413 is shown. As can be seen, magazine 413 comprises a container. Generally, the packages are assembled in a strip or lead frame which contains a plurality of packages. After final processing, the strip is separated to produce individual packages. Slots are provided on the interior of the magazine to hold the strips of packages. This enables the magazine to hold a stack the strips. Magazine 413 may have different widths to accommodate different types of or sized lead frames.

Perforations or openings 416 are provided on the surfaces of the magazine to allow components of plasma to pass through to clean the packages contained therein. As shown, the perforations are slot shaped. Other shaped perforations are also useful. FIG. 4(c) shows a magazine with perforated magazine covers 443 covering, for example, the ends 421 and 422.

In one embodiment, the charge shield comprises mesh. The mesh may be made from Aluminum with preferably 1×1 mm hole size. The hole size is important since the effectiveness of shielding varies for different wavelength. Alternatively, the mesh may also be made from other materials. The mesh acts as a Faraday Cage in preventing any of the external electric fields contributed by plasma components (both positive and negative) from entering the magazine. Both ions are blocked with the intention of preventing any accumulation of charges onto wire surface. As the wires were already charged as results of wire bonding process and or motion/transportation from point A to point B, any extra charges will create physical attraction between wires.

In one embodiment, a charge shield is provided for each magazine. This is the preferred embodiment for fully secured bonded units in the magazine while maintaining the cleaning process. The charge shield may completely enclose each magazine, including the perforated magazine covers; alternatively, it may only partially enclose the perforated magazine covers, i.e., the corner perforations of the cover are shielded with the charge shield, but the center perforations are not. Other configurations of charge shields are also useful. For example, a charge shield can be provided for the chamber or a charge shield can be provided for each level to encompass the magazines in the respective levels. Alternatively, charge shields can be provided to encompass different number or combinations of magazines.

An experiment was conducted comparing lots of packages with and without implementation of the charge shield as described. The results of the experiment shows that the % lot rejection rate during the experimental period without the charge shield is about 50% while with it is about 0%.

As such, the use of a charge shield can result in significant reduction or elimination of wire shorts as one of the electrical failure root causes while maintaining the plasma cleaning process needed to minimize delamination after encapsulation. Package performance can be maintained without incurring yield reduction.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A plasma clean tool comprising:
a cleaning chamber for cleaning an article by plasma cleaning;
a charge shield for surrounding an article to be cleaned, wherein the charge shield prevents charged components of plasma from passing therethrough to charge the article during plasma cleaning of the article.

2. The tool of claim 1 wherein the charge shield serves as a Faraday cage to prevent charged components of the plasma from accumulating on the article during plasma cleaning.

3. The tool of claim 1 wherein the charge shield comprises a mesh.

4. The tool of claim 1 comprises a handler on which articles to be cleaned are disposed.

5. The tool of claim 4 where the charge shield is integrated into the handler.

6. The tool of claim 1 wherein the plasma tool is used for cleaning wire bonded packages prior to encapsulation.

7. The tool of claim 6 comprises a magazine for containing strips of wired bonded packages for cleaning.

8. The tool of claim 7 wherein the charge shield is integrated into the handler.

9. A handler used in a plasma clean process of manufacturing integrated circuits (ICs) comprising:
a support on which articles to be cleaned are disposed; and
a charge shield surrounding the support to prevent passage of charge components of plasma from passing through and accumulate on the articles during plasma cleaning.

10. The handler of claim 9 wherein the charge shield comprises a mesh.

11. The handler of claim 10 wherein said mesh comprises mesh openings of about 1×1 mm.

12. The handler of claim 9 wherein the support comprises a magazine for containing strips of wired bonded packages to be cleaned.

13. The handler of claim 12 wherein the magazine comprises:
a container with a plurality of perforations; and
slots in the interior for holding a plurality of strips of wired bonded packages.

14. The handler of claim 13 wherein the charge shield comprises a mesh.

15. A method for fabricating a device comprising:
providing a device on a handler;
placing the handler in a plasma chamber;
providing a charge shield surrounding the device; and
cleaning the device by plasma cleaning in the plasma chamber, wherein charged components of plasma are prevented from passing through the shield and accumulating on the device.

16. The method of claim 15 wherein the charge shield comprises a mesh.

17. The method of claim 15 wherein the device comprises a wire bonded package prior to encapsulation.

18. The method of claim 17 wherein the charge shield prevents accumulation of charges on wires of the device to prevent shorting of the wires.

19. The method of claim 17 wherein the handler comprises a magazine for containing strips of wire bonded packages, wherein the magazine includes perforations for non-charged plasma components to circulate to clean the packages therein.

20. The method of claim 19 wherein a plurality of handlers are provided in the chamber.
